(19) United States
(12) Patent Application Publication
(10) Pub. No.: US 2024/0211809 A1
(43) Pub. Date: Jun. 27, 2024

(54) MACHINE LEARNING DEVICE

(71) Applicant: Rohm Co., Ltd., Kyoto (JP)

(72) Inventors: Koji Tamano, Kyoto (JP); Yuji Kurotsuchi, Kyoto (JP)

(21) Appl. No.: 18/598,564

(22) Filed: Mar. 7, 2024

Related U.S. Application Data
(63) Continuation of application No. PCT/JP2022/032026, filed on Aug. 25, 2022.

(30) Foreign Application Priority Data
Sep. 9, 2021 (JP) 2021-146742

(51) Int. Cl. G06N 20/00; G06N 5/04

(52) U.S. Cl. CPC G06N 20/00; G06N 5/04

(57) ABSTRACT

A machine learning device includes a data conversion unit configured to convert time series data inputted thereto into frequency feature quantity data, a machine learning inference unit configured to perform machine learning inference based on the frequency feature quantity data, and a computation circuit unit configured to be commonly used by the data conversion unit and the machine learning inference unit.

### CROSS-REFERENCE TO RELATED APPLICATIONS

This nonprovisional application is a continuation application of International Patent Application No. PCT/JP2022/032026 filed on Aug. 25, 2022, which claims priority Japanese Patent Application No. 2021-146742 filed on Sep. 9, 2021, the entire contents of which are hereby incorporated by reference.

### TECHNICAL FIELD

The present disclosure relates to a machine learning device.

### BACKGROUND ART

In recent years, there has been increasing attention on AI (artificial intelligence) technologies. Conventionally, machine learning inference, which utilizes various models such as neural networks, has been well-known in AI technologies (for the neural network, see Patent Document 1, for example).

### CITATION LIST

### Patent Literature

Patent Document 1: JP-A-H08-87484

### BRIEF DESCRIPTION OF DRAWINGS

FIG. 1 is a block diagram showing a functional configuration of a machine learning device according to an exemplary embodiment of the present disclosure.

FIG. 2 is a diagram showing a configuration example of a computation circuit unit.

FIG. 3 is a diagram showing a configuration example of an operator.

FIG. 4 is a diagram showing a first configuration example of the machine learning device.

FIG. 5 is a diagram showing a second configuration example of the machine learning device.

FIG. 6 is a diagram showing a configuration example of a neural network.

FIG. 7 is a diagram showing a configuration of a fully-connected layer.

FIG. 8 is a diagram showing a ReLU as an example of an activation function.

FIG. 9 is a diagram showing a sigmoid function as an example of the activation function.

FIG. 10 is a diagram showing another configuration example of the neural network.

FIG. 11 is a diagram showing a configuration of a machine learning device according to a modified example.

FIG. 12 is a diagram showing an example of pipelined computation processing.

FIG. 13 is a diagram showing a first application example of the machine learning device.

FIG. 14 is a diagram showing a second application example of the machine learning device.

### DESCRIPTION OF EMBODIMENTS

Hereinafter, exemplary embodiments of the present disclosure will be described with reference to the accompanying drawings.

### <1. Configuration of Machine Learning Device>

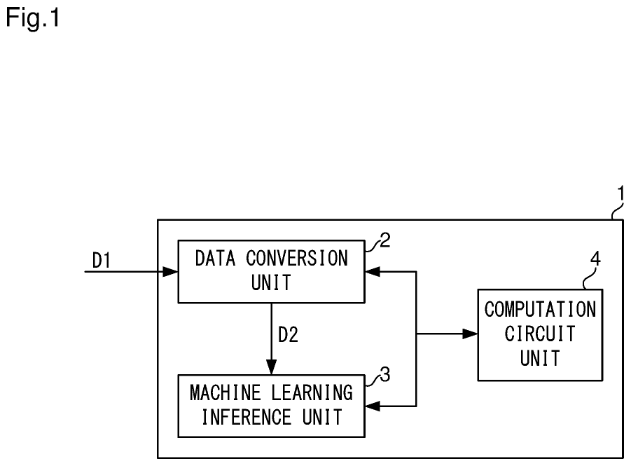

FIG. 1 is a block diagram showing a functional configuration of a machine learning device according to an exemplary embodiment of the present disclosure. A machine learning device 1 shown in FIG. 1 includes a data conversion unit 2, a machine learning inference unit 3, and a computation circuit unit 4.

The data conversion unit 2 performs conversion processing to convert time series data D1, which is inputted thereto from an outside of the machine learning device 1, into frequency feature quantity data D2. The frequency feature quantity data D2 is data that indicates the frequency feature quantity of the time series data D1. Used in the conversion processing described above is, for example, a Hadamard transform, a discrete Fourier transform, a discrete cosine transform, etc.

The machine learning inference unit 3 performs machine learning inference with the frequency feature quantity data D2 as an input, and outputs an inference result. The machine learning inference is performed using inference models such as a neural network, multiple regression analysis, etc. In a case of using the time series data D1 in the machine learning inference, it is possible to improve the accuracy of the machine learning inference by performing pre-processing in the conversion processing by the data conversion unit 2.

The computation circuit unit 4 is a computation circuit commonly used by both the data conversion unit 2 and the machine learning inference unit 3. Specifically, the data conversion unit 2 performs the conversion processing by using computation processing by the computation circuit unit 4, and the machine learning inference unit 3 performs the machine learning inference by using the computation processing performed by the computation circuit unit 4. Thus, by communizing the computation circuit unit 4, circuit size reduction is achieved in the machine learning device 1.

### <2. Configuration of Computation Circuit Unit>

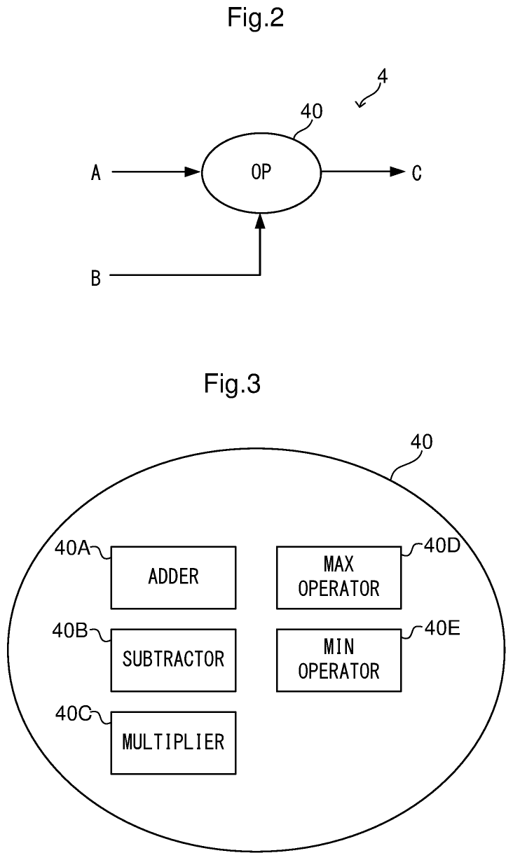

FIG. 2 is a diagram showing a configuration example of the computation circuit unit 4. As shown in FIG. 2, the computation circuit unit 4 includes an operator 40. The operator 40 performs computation processing based on a first computation input A and a second computation input B inputted thereto, and outputs a computation output C as a computation result.

The first computation input A and the second computation input B are each at least a matrix, a vector, or a scalar. At least either the first computation input A or the second computation input B may be allowed to be selected from two or more of a matrix, a vector, and a scalar corresponding to the computation processing to be executed. Further, the computation method of the operator 40 may be allowed to be selected, corresponding to the computation processing to be executed, from two or more computation methods (e.g., multiplication (product), maximum-value output, minimum-value output, etc.).

As an example, in the conversion processing by the data conversion unit 2, a matrix is selected as the first computation input A, a vector is selected as the second computation input B, multiplication is selected as the computation method of the operator 40, and a computation output C=AB is outputted. On the other hand, in the machine learning inference by the machine learning inference unit 3, as an example, there can be executed computation processing in which a matrix or a vector is selected as the first computation input A, a vector is selected as the second computation input B, multiplication is selected as the computation method of the operator 40, and the computation output C=AB is outputted, and computation processing in which a vector is selected as each of the first computation input A and the second computation input B, maximum-value output is selected as the computation method of the operator 40, and the computation output C=max (A, B) is outputted.

Further, corresponding to the computation processing to be executed, in at least either the first computation input A or the second computation input B, the size of at least either a matrix or a vector may be changeable. As an example, in the processing by the data conversion unit 2 and the processing by the machine learning inference unit 3, the size of the first computation input A which is a matrix and the size of the second computation input B which is a vector are changeable.

FIG. 3 is a diagram showing a configuration example of the operator 40. The operator 40 shown in FIG. 3 includes, for example, an adder 40A, a subtractor 40B, a multiplier 40C, a MAX operator 40D, and a MIN operator 40E. The MAX operator 40D performs a computation of outputting the maximum value among inputted values. The MIN operator 40E performs a computation of outputting the minimum value among inputted values.

The computation method of the operator 40 can be chosen via a selection on the operators included in the operator 40. For example, by selecting the adder 40A, the subtractor 40B, and the multiplier 40C, multiplication of the first computation input A and the second computation input B can be selected. By selecting the MAX operator 40D or the MIN operator 40E, the maximum-value output or the minimum-value output of the first computation input A and the second computation input B can be chosen.

Note that the configuration shown in FIG. 3 is merely an example, and the operators shown in FIG. 3 may be partly omitted or an operator (e.g., one that outputs an absolute value) other than those shown in FIG. 3 may be provided.

It is possible to commonize operators (e.g., the adder 40A and the subtractor 40B) used in the computation by the operator 40 executed in processing by the data conversion unit 2 and the processing by the machine learning inference unit 3, and thus it is possible to reduce the circuit size of the computation circuit unit 4.

### <3. First Configuration Example of Machine Learning Device>

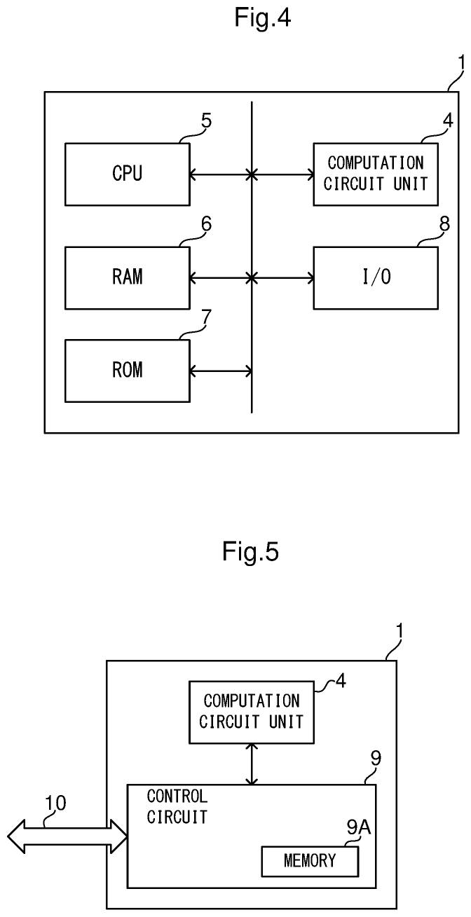

FIG. 4 is a diagram showing a first configuration example of the machine learning device 1. FIG. 4 shows a configuration example in which the previously-described functional configuration shown in FIG. 1 is further specified.

The machine learning device 1 according to the first configuration example shown in FIG. 4 includes, integrated therein, the computation circuit unit 4, a CPU (Central Processing Unit) 5, a RAM (Random Access Memory) 6, a ROM (Read Only Memory) 7, and an input/output unit (I/O) 8, and is configured as an MCU (Micro Control Unit).

The CPU 5 is a processor that operates according to a program stored in the ROM 7. The RAM 6 is a memory in which data is temporarily stored. In the RAM 6, for example, a result of computation by the CPU 5, the time series data D1, a result of computation by the computation circuit unit 4, etc. are stored. In the ROM 7, a program executed by the CPU 5 and the like are stored. The input/output unit 8 receives the time series data D1 externally inputted thereto, and outputs a result of machine learning inference, for example.

The CPU 5 executes the program stored in the ROM 7, and thereby controls the computation circuit unit 4. That is, the computation circuit unit 4 is controlled by means of software processing. For example, the CPU 5 performs control to select types and sizes of the first computation input A and the second computation input B, control to select a method of computation to be performed by the operator 40, etc. By the computation circuit unit 4, the CPU 5, the RAM 6, and the ROM 7, the data conversion unit 2 and the machine learning inference unit 3 (FIG. 1) are functionally implemented.

According to this first configuration example, as compared with a case where data conversion and machine learning inference are executed by means of computations performed by a CPU, it is possible to simultaneously achieve higher computation speed and lower power consumption.

### <4. Second Configuration Example of Machine Learning Device>

FIG. 5 is a diagram showing a second configuration example of the machine learning device 1. FIG. 5 shows a configuration example in which the previously-described functional configuration shown in FIG. 1 is further specified.

The machine learning device 1 according to the second configuration example shown in FIG. 5 includes, integrated therein, the computation circuit unit 4 and a control circuit 9. The control circuit 9 includes a memory 9A. In the memory 9A, for example, the time series data D1, a result of computation by the computation circuit unit 4, etc. are stored. The control circuit 9 is configured to be capable of performing communication 10 with the outside of the machine learning device 1.

The control circuit 9 controls the computation circuit unit 4 based on the communication 10. For example, the control circuit 9 performs control to select the types and the sizes of the first computation input A and the second computation input B, control to select the method of computation to be performed by the operator 40, etc. By the computation circuit unit 4 and the control circuit 9, the data conversion unit 2 and the machine learning inference unit 3 (FIG. 1) are functionally implemented.

### <5. Processing by Data Conversion Unit>

For the data conversion processing in the data conversion unit 2, various processing methods can be used.

As the data conversion processing mentioned above, for example, the Hadamard transform can be suitably used. The Hadamard transform is performed by the product of a Hadamard matrix and an input vector. Here, a Hadamard matrix Hₖ of 2^{k}×2^{k} can be obtained recursively as shown in the following expression.

$${H}_{0} = 1 , {H}_{k} = \frac{1}{\sqrt{2}} ( \begin{matrix}{H}_{k - 1} & {H}_{k - 1} \\ {H}_{k - 1} & - {H}_{k - 1}\end{matrix} )$$

In the execution of the Hadamard transform by the computation circuit unit 4, the first computation input A is a Hadamard matrix, the second computation input B is an input vector that is the time series data D1, and computation of C=AB is executed, by means of which the computation output C can be obtained as the frequency feature quantity data D2. An element of a Hadamard matrix is only either +1 or −1. Accordingly, the operator 40 is capable of implementing the multiplication (product) of A and B merely through calculations by the adder 40A and the subtractor 40B.

Thus, with a Hadamard transform used for the conversion processing in the data conversion unit 2, there is no need of providing an operator that performs complex operations such as trigonometric functions and the like necessary in the discrete Fourier transform and the like.

Note that, in a case of using the discrete Fourier transform, the discrete cosine transform, or the like for the data conversion processing in the data conversion unit 2, if a table of values of elements represented by trigonometric functions in the matrix used for the conversion is provided in advance, there is no need to provide a trigonometric-function operator. Let the first computation input A be the matrix mentioned above, and let the second computation input B be an input vector, then the discrete Fourier transform or the discrete cosine transform can be executed by the product of A and B.

### <6. Processing by Machine Learning Inference Unit>

Inference processing in the machine learning inference unit 3 can be executed by using various inference models. For example, a neural network can be used as an inference model.

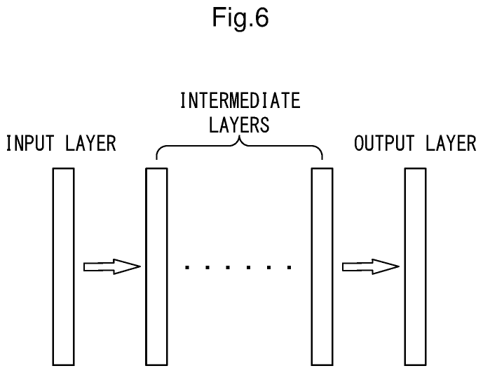

FIG. 6 is a diagram showing a configuration example of the neural network. The neural network shown in FIG. 6 includes an input layer, which is a first layer, an output layer, which is a last layer, and a plurality of intermediate (hidden) layers disposed between the input and output layers.

The layers of the neural network each include a node. Each node in each of the intermediate and output layers is connected to all nodes in the previous layer, forming a fully-connected layer between each layer. As data in the input layer, the frequency feature quantity data D2 is used.

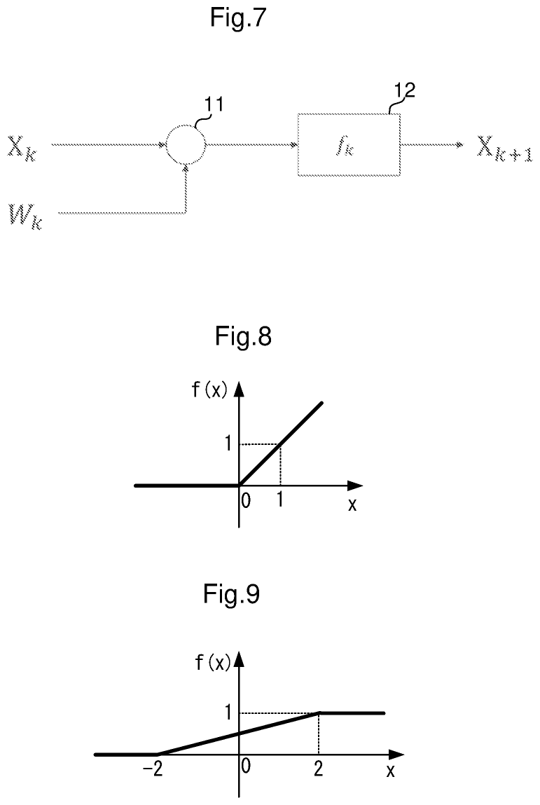

FIG. 7 is a diagram showing a configuration of a fully-connected layer. As shown in FIG. 7, the fully-connected layer includes a matrix product calculation unit 11 and an activation function 12.

The matrix product calculation unit 11 calculates a product of a weight matrix Wₖ and an input vector Xₖ. Then, the result of the calculation by the matrix product calculation unit 11 is inputted into the activation function 12, which outputs vector Xₖ₊₁. That is, the following expression holds.

$${X}_{k + 1} = {f}_{k} ( {W}_{k} \cdot {X}_{k} )$$

The computation performed in the matrix product calculation unit 11 is performed, by selecting the adder 40A, the subtractor 40B, and the multiplier 40C in the operator 40 of the computation circuit unit 4, with the weight matrix Wₖ as the first computation input A and the input vector Xₖ as the second computation input B, to output a computation output C as a vector such that C=AB.

As the activation function 12, a ReLU (Rectified Linear Unit) is used, for example. The ReLU is represented by the following expression, and illustrated as in FIG. 8.

$$f ( x ) = \{ \begin{matrix}0 , & x < 0 \\ x , & x \geq 0\end{matrix}$$

where x represents an element of a vector.

The computation by the ReLU is implemented by selecting the MAX operator 40D in the operator 40. The MAX operator 40D performs computation by max (a, b) to output whichever is the larger (the maximum value) of a and b. With f(x)=max (x, 0), the computation by the ReLU can be executed.

Besides, for example, a sigmoid function may be used as the activation function 12. The sigmoid function is represented by the following expression, and is illustrated as in FIG. 9.

$$f ( x ) = \frac{1}{1 + exp ( x )} ≅ \{ \begin{matrix}0 , & x < - 2 \\ 0.25 x + 0.5 , & - 2 \leq x \leq 2 \\ 1 , & 2 < x\end{matrix}$$

The computation by the sigmoid function is implemented by selecting, in the operator 40, the multiplier 40C, the adder 40A, the MAX operator 40D, and the MIN operator 40E. The MIN operator 40E performs computation by min (a, b) to output whichever is the smaller (the minimum value) of a and b. With f(x)=min (max (0.25x+0.5,0),1), the computation by the sigmoid function can be performed.

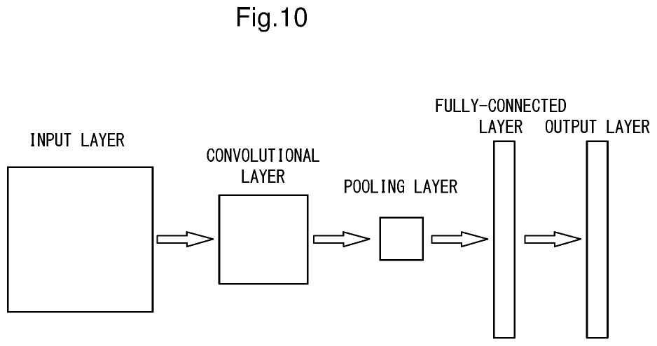

FIG. 10 is a diagram showing another configuration example of the neural network. The neural network shown in FIG. 10 includes an input layer, a convolutional layer disposed on the post stage of the input layer, a pooling layer disposed on the post stage of the convolutional layer, a fully-connected layer disposed on the post-stage of the pooling layer, and an output layer disposed on the post-stage of the fully-connected layer. The fully-connected layer may be a single fully-connected layer or may include a plurality of fully-connected layers.

First, in the convolutional layer, filtering processing is performed with respect to an entire input image inputted to the input layer. The convolutional layer is constituted of a product of a weight and input image data corresponding to a partial region, as well as an activation function. Note that the processing is performed by shifting the partial region. Accordingly, the computation performed in the convolutional layer by the operator 40 is implemented by selecting the multiplier 40C, the adder 40A, the subtractor 40B, and the MAX operator 40D (in the case where the activation function is a sigmoid function, the MIN operator 40E is also selected).

The image having undergone the processing in the above-described convolutional layer is then processed by the pooling layer. The pooling layer outputs one value from a partial region in the image having undergone the above-described processing. Note that the processing is performed by shifting the partial region. For example, in a case where the pooling layer is a Max pooling layer, it performs computation to output the maximum value of each pixel data in the partial region.

Note that inference processing in the machine learning inference unit 3 is not limited to the neural network, and may be performed by using other models, such as multiple regression analysis and PCA (Principal Component Analysis), which can be represented or approximated by linear transformation.

### <7. Modified Example of Machine Learning Device>

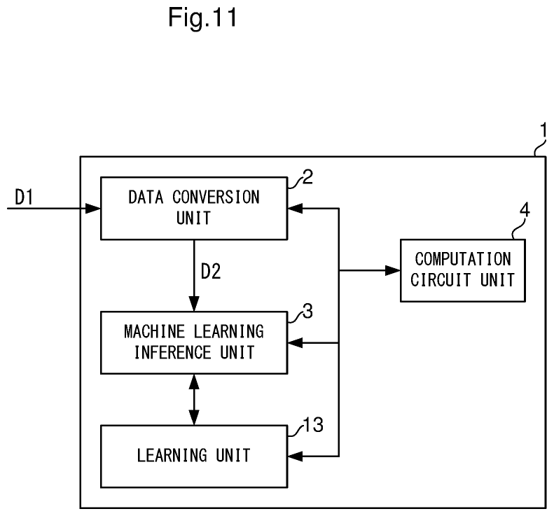

FIG. 11 is a diagram showing a configuration of a machine learning device 1 according to a modified example. The machine learning device 1 shown in FIG. 11 is provided with a learning unit 13 in addition to the previously-described configuration (FIG. 1). The learning unit 13 updates a parameter of the model in the machine learning inference unit 3. The computation circuit unit 4 is commonly used by the data conversion unit 2, the machine learning inference unit 3, and the learning unit 13.

For example, in a case where the model in the machine learning inference unit 3 is a neural network, according to gradient descent, which is generally used for neural network learning, a weight matrix W is updated as follows. Here,

$${{w}_{ij}}^{′} = {w}_{ij} - η \frac{\partial L}{\partial {w}_{ij}}$$

where, wᵢⱼ represents an ith-row jth-column element of a weight matrix W, η represents a learning rate, and L represents a loss function.

In a case where the neural network model is defined as Y=W·X, and the loss function is defined as L=(½)|Y−Y′|², the weight matrix W is updated by the following update expression.

$${W}^{′} = W - η {X}^{T} ( W \cdot X - {Y}^{′} )$$

where Y′ represents training data, and X^{T} represents a transpose matrix of X.

Thus, the learning unit 13 can perform computation according to the above update expression by selecting the adder 40A, the subtractor 40B, and the multiplier 40C in the operator 40 in the computation circuit unit 4. In this manner, even in the case where the learning unit 13 is provided, increase in circuit size can be suppressed by commonizing the computation circuit unit 4.

### <8. Pipelining of Computation Processing>

The computation processing in the computation circuit unit 4 may be pipelined in the following manner. Here, a description will be given by taking, as an example, the previously-described machine learning device 1 of the first configuration example (FIG. 4). The computation processing is, for example, divided into four steps as described below.

(First Step) The CPU 5 calculates a memory address for reading the first computation input A and the second computation input B from the RAM 6, a memory address for writing the computation output C to the RAM 6, and a memory address for reading selection information of the operator 40 (OP) from the RAM 6.

(Second Step) A, B and the selection information of the operator 40 are read from the calculated memory addresses.

(Third Step) A computation is executed (C=A OP B).

(Fourth Step) C is written to the calculated memory address.

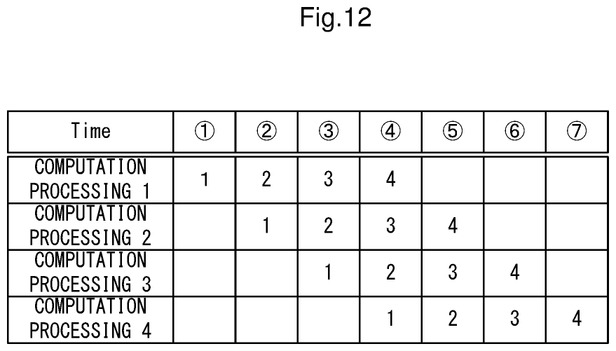

And, as shown in FIG. 12 as an example, the pipelining of the computation processing is performed. In FIG. 12, in computation processing 1, the first to fourth steps are executed in order. At the start of the second step in computation processing 1, the first step in computation processing 2 is started and the subsequent steps through the fourth step are executed. At the start of the second step in computation processing 2, the first step in computation processing 3 is started and the subsequent steps through the fourth step are executed. At the start of the second step in computation processing 3, the first step in computation processing 4 is started and the subsequent steps through the fourth step are executed.

In this manner, by the parallel execution of the computation processing, throughput can be improved. Note that, if the second step and the fourth step cannot be executed simultaneously, which is often the case, the second step and the fourth step are executed in a staggered manner.

### <9. Application Example of Machine Learning Device>

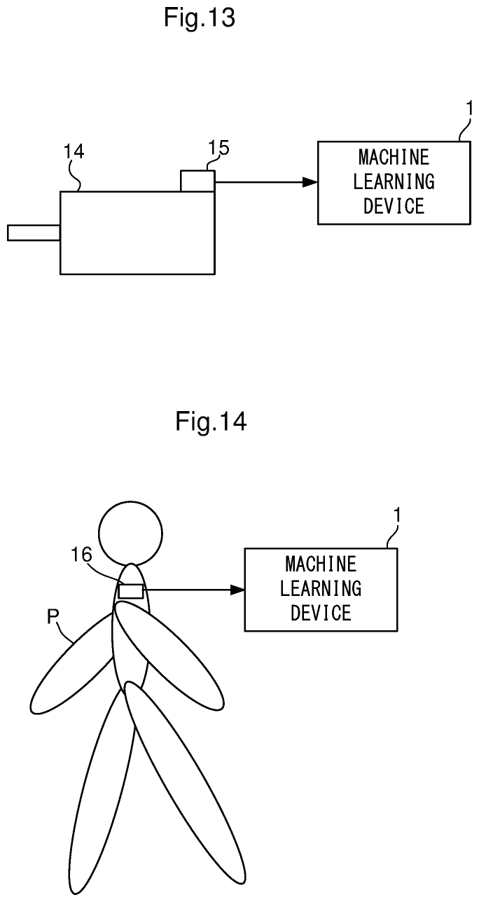

Described here is an example of preferable application targets of the machine learning device 1 according to the present disclosure. FIG. 13 is a diagram showing a first application example of the machine learning device 1. In the configuration shown in FIG. 13, a sensor 15 is secured to a motor 14, and vibration data is inputted from the sensor 15 to the machine learning device 1. The vibration data is an example of the time series data D1. The sensor 15 is constituted of, for example, an acceleration sensor, a gyro sensor, etc.

According to this configuration, the vibration data indicating the state of vibration of the motor 14 is inputted to the machine learning device 1 to be converted into the frequency feature quantity data D2, and then the machine learning inference is executed based on the frequency feature quantity data D2. This makes it possible to infer the state of the motor 14, such as a stopped state, an abnormally vibrating state, and other states of the motor 14.

FIG. 14 is a diagram showing a second application example of the machine learning device 1. In the configuration shown in FIG. 14, a sensor 16 is secured to a human body P, and vibration data is inputted from the sensor 16 to the machine learning device 1. According to this configuration, after the vibration data indicating the state of vibration of the human body P is inputted to the machine learning device 1 to be converted into the frequency feature quantity data D2, the machine learning inference is executed based on the frequency feature quantity data D2. This makes it possible to infer the state of the human body P, such as a standing state, a running state, and other states of the human body P.

### <10. Others>

Note that the various technical features according to the present disclosure may be implemented in any other manners than in the embodiments described above, and allow for any modifications made without departure from their technical ingenuity. That is, it should be considered that the above embodiments are illustrative in all respects and are not limiting, and it should be understood that the technological scope of the present invention is not limited to the above description of the embodiments, and that all modifications within the scope of the claims and the meaning equivalent to the claims are covered.

### <11. Supplementary Notes>

As described above, for example, according to the present disclosure, a machine learning device (1) includes a data conversion unit (2) configured to convert time series data (D1) inputted thereto into frequency feature quantity data (D2), a machine learning inference unit (3) configured to perform machine learning inference based on the frequency feature quantity data, and a computation circuit unit (4) configured to be commonly used by the data conversion unit and the machine learning inference unit (a first configuration).

Further, in the above first configuration, the computation circuit unit (4) may be configured to be capable of executing computation by using an operator (40) configured to output a computation output based on a first computation input (A) and a second computation input (B), and the machine learning device (1) may include a control unit (5, 9) configured to be capable of executing first control to select at least either a type or a size of at least either the first computation input or the second computation input and second control to select a method of computation to be performed by the operator (a second configuration).

Further, in the above second configuration, the types may be at least two of a matrix, a vector, and a scalar (a third configuration).

Further, in the above second or third configuration, the control unit may be a processor (5) configured to execute the first control and the second control by executing a program (a fourth configuration).

Further, in the above second or third configuration, the control unit may be a control circuit (9) configured to execute the first control and the second control based on communication with an outside of the machine learning device (a fifth configuration).

Further, in any one of the above first to fifth configurations, the data conversion unit (2) may be configured to convert the time series data (D1) into the frequency feature quantity data (D2) via a Hadamard transform, by the computation circuit unit (4) computing a product of a Hadamard matrix and an input vector by using an adder (40A) and a subtractor (40B) (a sixth configuration).

Further, in any one of the above first to fifth configurations, the data conversion unit (2) may be configured to convert the time series data (D1) into the frequency feature quantity data (D2) via a discrete Fourier transform or a discrete cosine transform, by the computation circuit unit (4) computing a product of a conversion matrix having a trigonometric function value as a table value and an input vector (a seventh configuration).

Further, in any one of the above first to seventh configurations, the machine learning inference unit (3) may be configured to perform machine learning inference by using a neural network, the neural network may include a fully-connected layer, and the computation circuit unit (4) may be configured to execute computation in the fully-connected layer (an eighth configuration).

Further, in the above eighth configuration, the computation circuit unit (4) may be configured to compute, in the fully-connected layer, a product of a weight matrix and an input vector (a ninth configuration).

Further, in the above eighth or ninth configuration, the computation circuit unit (4) may be configured to execute, in the fully-connected layer, via max (a, b) to output whichever of a and b is the larger, computation of an activation function f(x)=max (x, 0) (a tenth configuration).

Further, in the above eighth or ninth configuration, the computation circuit unit (4) may be configured to execute, in the fully-connected layer, via max (a, b) to output whichever of a and b is the larger and min (a, b) to output whichever of a and b is the smaller, computation of an activation function f(x)=min (max (0.25x+0.5,0), 1) (an eleventh configuration).

Further, in any one of the above first to eleventh configurations, there may be further included a learning unit (13) configured to perform machine learning of the machine learning inference unit (3), and the computation circuit unit (4) may be configured to be commonly used by the data conversion unit (2), the machine learning inference unit, and the learning unit (a twelfth configuration).

Further, in any one of the above first to twelfth configurations, the computation circuit unit (4) may be configured to be capable of executing computation by using an operator (40) configured to output a computation output (C) based on a first computation input A) and a second computation input (B), computation processing executed by the computation circuit unit may include a first step of calculating a memory address of where each of the first computation input, the second computation input, the computation output, and data regarding the operator is stored, a second step of reading each of the first computation input, the second computation input, and the data regarding the operator from the memory address, a third step of executing computation based on the first computation input, the second computation input, and the operator, and a fourth step of writing the computation output to the memory address, and the first step in a subsequent execution of the computation processing may be started before the computation processing is completed (a thirteenth configuration).

Further, in any one of the above first to thirteenth configurations, the machine learning device (1) may be configured to be capable of having vibration data from a sensor 15, 16) inputted thereto as the time series data (D1).

### INDUSTRIAL APPLICABILITY

The present disclosure can be used in, for example, machine learning inference based on various time series data.

### REFERENCE SIGNS LIST

1 machine learning device
2 data conversion unit
3 machine learning inference unit
4 computation circuit unit
5 CPU
6 RAM
7 ROM
8 input/output unit
9 control circuit
9A memory
10 communication
11 matrix product calculation unit
12 activation function
13 learning unit
14 motor
15, 16 sensor
40 operator
40A adder
40B subtractor
40C multiplier
40D MAX operator
40E MIN operator
P human body

1. A machine learning device, comprising:
a data conversion unit configured to convert time series data inputted thereto into frequency feature quantity data;
a machine learning inference unit configured to perform machine learning inference based on the frequency feature quantity data; and
a computation circuit unit configured to be commonly used by the data conversion unit and the machine learning inference unit.

2. The machine learning device according to claim 1,
wherein
the computation circuit unit is configured to be capable of executing computation by using an operator configured to output a computation output based on a first computation input and a second computation input, and
the machine learning device includes a control unit configured to be capable of executing
first control to select at least either a type or a size of at least either the first computation input or the second computation input and
second control to select a method of computation to be executed by the operator.

3. The machine learning device according to claim 2,
wherein
the types are at least two of a matrix, a vector, and a scalar.

4. The machine learning device according to claim 2,
wherein
the control unit is a processor configured to execute the first control and the second control by executing a program.

5. The machine learning device according to claim 2,
wherein
the control unit is a control circuit configured to execute the first control and the second control based on communication with an outside of the machine learning device.

6. The machine learning device according to claim 1,
wherein
the data conversion unit is configured to convert the time series data into the frequency feature quantity data via a Hadamard transform, by the computation circuit unit computing a product of a Hadamard matrix and an input vector by using an adder and a subtractor.

7. The machine learning device according to claim 1,
wherein
the data conversion unit is configured to convert the time series data into the frequency feature quantity data via a discrete Fourier transform or a discrete cosine transform, by the computation circuit unit computing a product of a conversion matrix having a trigonometric function value as a table value and an input vector.

8. The machine learning device according to claim 1,
wherein
the machine learning inference unit is configured to perform machine learning inference by using a neural network,
the neural network includes a fully-connected layer, and
the computation circuit unit is configured to execute computation in the fully-connected layer.

9. The machine learning device according to claim 8,
wherein
the computation circuit unit is configured to compute, in the fully-connected layer, a product of a weight matrix and an input vector.

10. The machine learning device according to claim 8,
wherein
the computation circuit unit is configured to execute, in the fully-connected layer, via max (a, b) to output whichever of a and b is the larger, computation of an activation function f(x)=max (x, 0).

11. The machine learning device according to claim 8,
wherein
the computation circuit unit is configured to execute, in the fully-connected layer, via max (a, b) to output whichever of a and b is the larger and min (a, b) to output whichever of a and b is the smaller, computation of an activation function f(x)=min (max (0.25x+0.5,0), 1).

12. The machine learning device according to claim 1,
wherein
there is further included a learning unit configured to perform machine learning of the machine learning inference unit, and
the computation circuit unit is configured to be commonly used by the data conversion unit, the machine learning inference unit, and the learning unit.

13. The machine learning device according to claim 1,
wherein
the computation circuit unit is configured to be capable of executing computation by using an operator configured to output a computation output based on a first computation input and a second computation input,
computation processing executed by the computation circuit unit includes
a first step of calculating a memory address of where each of the first computation input, the second computation input, the computation output, and data regarding the operator is stored,
a second step of reading each of the first computation input, the second computation input, and the data regarding the operator from the memory address,
a third step of executing computation based on the first computation input, the second computation input and the operator, and
a fourth step of writing the computation output to the memory address, and
the first step in a subsequent execution of the computation processing is started before the computation processing is completed.

14. The machine learning device according to claim 1 configured to be capable of having vibration data from a sensor inputted thereto as the time series data.
